(19) United States
(12) Patent Application Publication
(10) Pub. No.: US 2005/0285732 A1
(43) Pub. Date: Dec. 29, 2005

(54) Radio frequency identification based system to track consumption of medication

(76) Inventors: Uttam K. Sengupta, Portland, OR (US); Nikhil M. Deshpande, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/877,734

(22) Filed: Jun. 25, 2004

(51) Int. Cl. G08B 1/08

(52) U.S. Cl. 340/539.12; 340/309.7

(57) ABSTRACT

A radio frequency identification (RFID) based system to track consumption of medicine is disclosed. An RFID reader monitors a signal pattern of an RFID tag contained within medication. The signal pattern includes a medication identifier and a signal level over time. The signal pattern is compared to known ingestion profiles to distinguish between consumed and non-consumed medication.

### BACKGROUND

Description of the Related Art

As the general population becomes older and/or sicker, there may be an increased need for remote monitoring. For example, an aging adult on prescription medication may choose to live alone or a patient with a critical illness such as cancer may be required to take a combination of medication. With age or sickness, memory capability may decrease and a patient may take incorrect dosages or combinations of medicine. Physicians currently need to resort to regular blood and other such tests to determine if the proper medication was taken. Missed or incorrect dosages of medicine may cause serious side effects.

### BRIEF DESCRIPTION OF THE DRAWINGS

The present invention may be better understood, and its numerous features and advantages made apparent to those skilled in the art by referencing the accompanying drawings.

FIG. 1 illustrates a system for remote monitoring consumption of medication according to an embodiment of the present invention.

FIG. 2 illustrates a flow diagram of remote client monitoring at a client site according to an embodiment of the present invention.

FIG. 3 illustrates a flow diagram of remote client monitoring at a monitoring site according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

Types of wireless communication systems intended to be within the scope of the present invention include, although not limited to, Wireless Local Area Network (WLAN), Wireless Wide Area Network (WWAN), Worldwide Interoperability for Microwave Access (WiMax), Wireless Personal Area Network (WPAN), Wireless Metropolitan Area Network (WMAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, Universal Mobile Telecommunications System (UMTS), and the like, although the scope of the invention is not limited in this respect.

In at least one implementation, for example, a wireless link is implemented in accordance with the Bluetooth short range wireless protocol (Specification of the Bluetooth System, Version 1.2, Bluetooth SIG, Inc., November 2003, and related specifications and protocols). Other possible wireless networking standards include, for example: IEEE 802.11 (ANSI/IEEE Std 802.11-1999 Edition and related standards), IEEE 802.16 (ANSI/IEEE Std 802.16-2002, IEEE Std 802.16a, March, 2003 and related standards), HIPERLAN 1, 2 and related standards developed by the European Telecommunications Standards Institute (ETSI) Broadband Radio Access Networks (BRAN), HomeRF (HomeRF Specification, Revision 2.01, The HomeRF Technical Committee, July, 2002 and related specifications), and/or others.

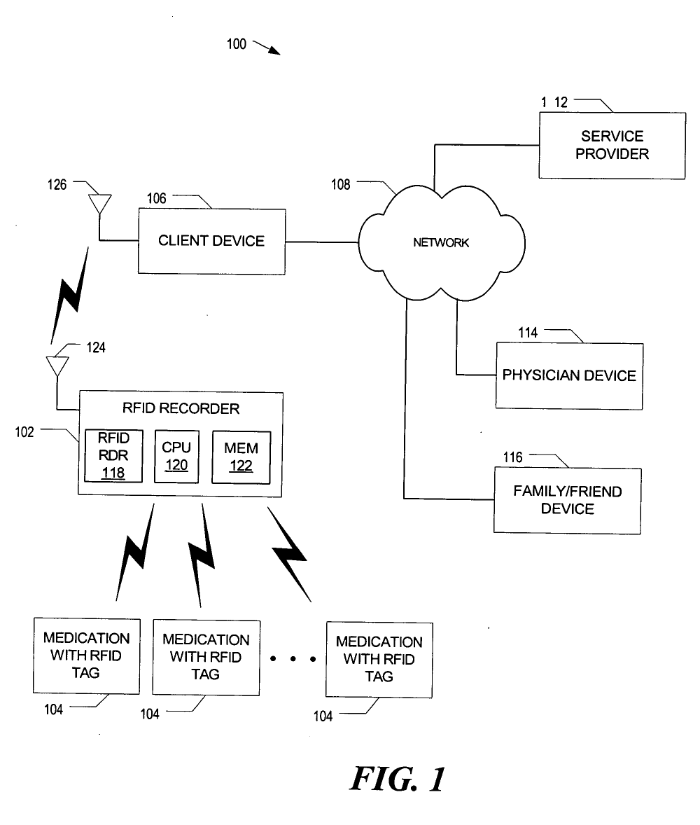

FIG. 1 illustrates a system 100 for remote monitoring consumption of medication according to an embodiment of the present invention. System 100 may include a recording device 102 in wireless communication with multiple radio frequency identification (RFID) tags contained within client medication 104. Recording device 102 may be in wireless communication with client device 106. Client device 106 may be connected to network 108. A service provider 112, a physician device 114 and a family/friend device 116 may also be connected to network 108. Although monitoring system 100 comprises a limited number of nodes as shown in FIG. 1, it may be appreciated that system 100 may comprise any number of additional nodes in any number of different network topologies. The embodiments are not limited in this context.

Client medication 104 may include pills, tablets, capsules or other form of medication having an edible and safe for human consumption RFID tag. Each different type of medication may have a different unique RFID. The RFID tags may be passive, although embodiments are not limited in this context. Passive RFID tags transmit a stream of information in response to an interrogation signal, such as an electromagnetic signal at a predetermined operating frequency. Passive RFID tags typically have no power source, and rely upon the energy delivered by the interrogation signal to transit the stream of information. Active RFID tags may have a power source such as a direct current (DC) battery. Active RFID tags may transmit a stream of information on a continuous basis, a periodic basis, or in response to some external event.

In one embodiment, recording device 102 collects monitoring information and transmits the information to the client device 106. Recording device 102 may be integrated into a device worn by a monitored person, such as a watch, necklace, ring, eyeglass, and other unobtrusive forms that may be worn on the body. Recording device 102 scans the monitored person for the consumption of particular pills. Particular pills are identified using RFID tags. The type of medicine and the amount of medicine consumed may be monitored.

Consumption of medicine may be distinguished from medicine in a jar or in a client's pocket in a variety of manners. For example, as a particular pill is consumed, the RFID signal pattern transmitted changes over time. The signal pattern may be come weaker along a known consumption curve. Alternatively, the signal pattern may change as the pill is consumed, for example, as particular components are dissolved due to stomach acids. Experiments may be conducted to create known ingestion profiles for specific medication in a controlled environment. Ingestion profiles may be created for a variety of detection devices. In addition, ingestion profiles for various user positions such as upright (standing, sitting, walking) versus prone (lying) may be used. In various embodiments of the present invention, comparison of the signal pattern to an ingestion profile may be performed by any component in the system, for example, recording device 102, client device 106, or service provider 112. The embodiments are not limited in this context.

Recording device 102 may include, for example, an RFID reader 118, a central processing unit 120, memory 122 for storing monitoring data, and one or more antennas 124 to communicate recorded RFID signal pattern information to client device 106. In one embodiment, recording device 102 may transmit information previously stored in memory. The embodiments are not limited in this context.

Client device 106 may comprise any processing system arranged to communicate monitoring information between recording device 102 and network 108. Examples of client device 106 may include a personal computer (PC), laptop computer, ultra-portable computer, handheld computer, cellular telephone, personal digital assistant (PDA), client capability built into an access point, smart phone, and the like. For example, client device 106 may comprise a PC having client application software. The client application software may be an agent for a monitoring service provider that is arranged to interact with server application software to provide monitoring services. The client application software may be arranged to perform a number of different client operations, such as subscribe to a monitoring service, receive configuration and control information for client device 106 and recording device 102, perform tests for various devices, perform authentication and encryption operations, send monitoring information to server 108 via network 106, and so forth. In standard operating mode, for example, client device 106 may periodically synchronize with recording device 102 and receive its monitoring information, open a data connection with service provider 112 via network 108, and communicate the monitoring information to service provider 112, physician device 114, or family/friend device 116. Similarly, service provider 112 may communicate control or configuration information to client device 106 and/or recording device 102 via network 108. The embodiments are not limited in this context.

Client device 106 may include one or more antennas 126 for communicating with recording device 102. In one embodiment, recording device 102 and client device 106 may communicate information in accordance with a number of different wireless protocols. Examples of such wireless protocols may include the 802.11 family of protocols, Bluetooth, Ultra Wide Band (UWB), and so forth. The embodiments are not limited in this context.

In one embodiment, system 100 may include network 108. Network 108 may comprise any type of network arranged to communicate information between the various nodes of system 100. For example, network 108 may comprise a packet data network such as a Local Area Network (LAN) or Wide Area Network (WAN), a Public Switched Telephone Network (PSTN), a wireless network such as cellular telephone network or satellite network, or WLAN, WMAN, WWAN, or any combination thereof. Network 108 may communicate information in accordance with any number of different data communication protocols, such as one or more Ethernet protocols, one or more Internet protocols such as the Transport Control Protocol (TCP) Internet Protocol (IP), Wireless Access Protocol (WAP), and so forth. The embodiments are not limited in this context.

In one embodiment, service provider 112 may receive monitoring information from client device 106 via network 108. In general operation, system 100 may operate to allow a first person to remotely monitor a second person. Physician device 114 and/or family/friend device 116 may receive monitoring information from service provider 112 or directly from client device 106. Service provider 112, physician device 114, and family/friend device 116 may use the monitoring information to generate status information that allows a user to quickly assess the health or physical status of a monitored person.

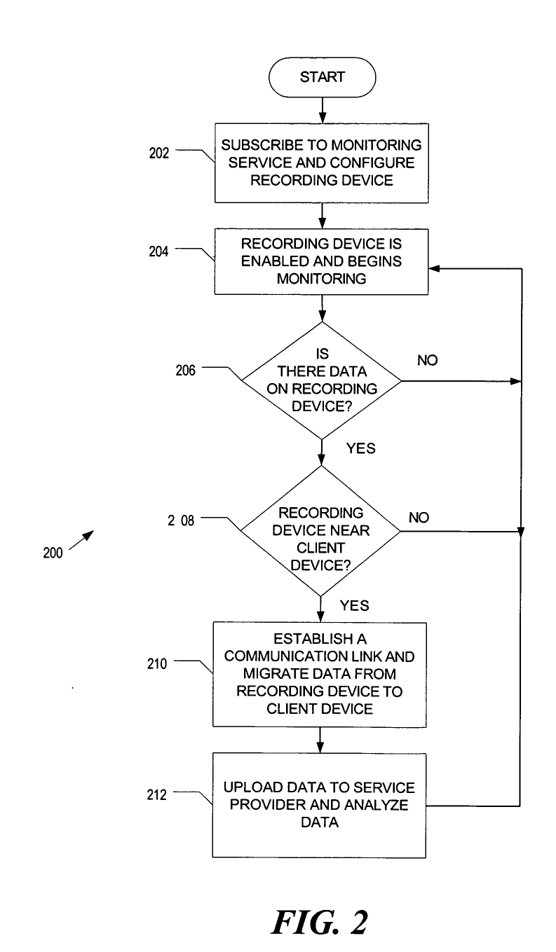

FIG. 2 illustrates a flow diagram 200 of remote client monitoring at a client site according to an embodiment of the present invention. A monitored person or someone acting on their behalf subscribes to a monitoring service and configures a recording device, block 202. Subscribing to a monitoring service and configuring the recording device may include the monitored person launching a client program on the client device, for example, a personal computer. The client program may guide the user through a sign up process, for example, prompting for user name and password, an identification of others who would access the monitoring data such as a physician, a family memory or a friend. Security checks required for authentication, for example, a public key, biometrics, and the like may be configured. The service provider may send a nominally configured device such as watch or locket and the client may complete the configuration by testing whether the device is able to interact with RFID tags.

The recording device is enabled, and begins monitoring the client, block 204. The monitored person, wearing the recording device, resumes normal activity and ingests medication. The recording device may detect an RFID signal at a certain threshold level (to indicate, for example, that the patient is holding a medication bottle) and may activate the recording software. The recording device may record information such as a data/time stamp, a unique identification of the medication, a signal strength, and an upright or prone status of the client.

Periodically, the recording device determines if monitoring information is available for download to the client device, block 206. If not, monitoring continues, block 204. If information is available for download, the recording device determines if the client device is within range, block 208. If not, monitoring continues, block 204. If the recording device is within a proximity of the client device for accurate download, a communication link between the recording device and the client device is established and data is downloaded, block 210. Periodically, the client device uploads the monitoring information to the service provider, block 212. The service provider may analyze the data, comparing for example, the data to known medication ingestion profiles. In an alternate embodiment, the client device or the recording device compares the data to known medication ingestion profiles.

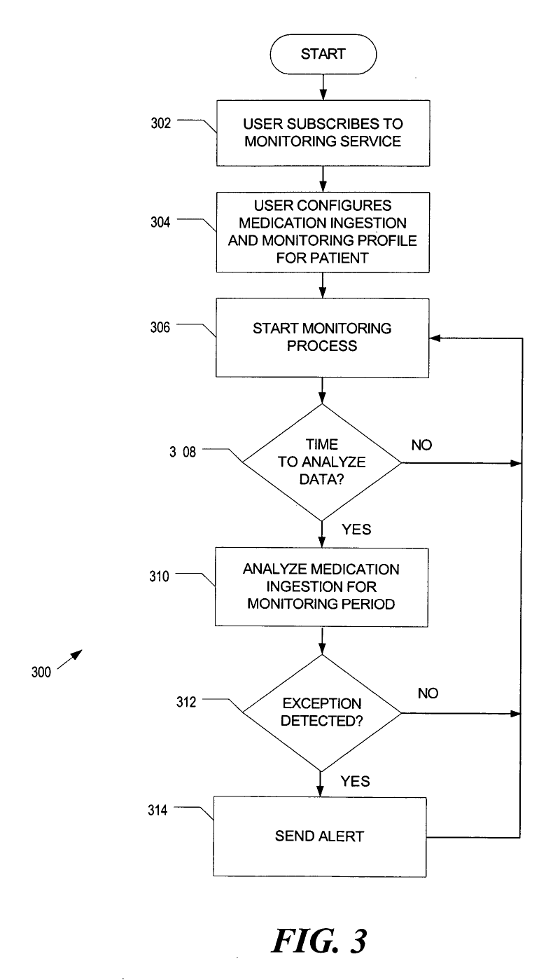

FIG. 3 illustrates a flow diagram of remote client monitoring at a monitoring site according to an embodiment of the present invention. Flow 300 illustrates the server-end of the client-server system and handles the interaction with the clients such as the sign up process, configuration, user authentication, data upload, data download, and the like. A user, for example, a person to be monitored or someone acting on their behalf such as a physician, a family member or a friend, subscribes to the monitoring service, block 302. The user configures the patients expected medication ingestion information and a monitoring profile for the patient. For example, thresholds for alerts may be set, types of medication and dosage information may be configured. The monitoring process is started and monitoring commences receiving monitoring data from a client device via, for example, a network, block 306. A determination is made whether the gathered data should be analyzed, block 308. If not, monitoring continues, block 306. If the data is to be analyzed, the received monitoring information for the monitoring period is analyzed, block 310. A determination is made whether an exception is detected, block 312. An exception could occur when, for example, a critical dosage is missed, wrong medication is taken, or too much medication is taken. If no exception is detected, monitoring continues, block 306. If an exception is detected, an alert is sent, block 314. The alert may be sent to a physician, a family member or a friend. For emergency conditions, an alert may be sent to a local 911 service for immediate care.

Embodiments of the present invention provide a novel way to keep track of patients when they are self medicating themselves. Embodiments of the present invention will allow physicians to monitor remotely the medication ingestion patterns and proactively take action if patients miss a dose or take the incorrect dosage of medication.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

1. A method comprising:
monitoring a signal pattern of a radio frequency identification (RFID) tag contained within medication; and
uploading the signal pattern to a client device.

2. The method as recited in claim 1, wherein the monitoring the signal pattern comprises recording an RFID identifying the medication and changes in a signal strength over time.

3. The method as recited in claim 1, further comprising storing the signal pattern.

4. The method as recited in claim 1, wherein the monitoring comprises:
comparing the signal pattern to an ingestion profile to distinguish between consumption of the medication and non-consumption of the medication.

5. The method as recited in claim 1, wherein the uploading is via a wireless communication link.

6. The method as recited in claim 5, wherein the wireless communication link is an ultra-wideband link.

7. The method as recited in claim 5, wherein the wireless communication link is a Bluetooth link.

8. The method as recited in claim 1, further comprising:
upon detecting the signal pattern having a signal strength above a threshold strength, beginning the monitoring.

9. A method comprising:
receiving a monitored signal pattern of a radio frequency identification (RFID) tag contained within medication;
comparing the signal pattern to an ingestion profile to distinguish between consumption of the medication and non-consumption of the medication.

10. The method as recited in claim 9, wherein the ingestion profile is designated for a particular medication and comprises a signal strength signature that fluctuates and then decreases over time.

11. The method as recited in claim 9, wherein the ingestion profile is designated for a particular patient orientation.

12. The method as recite din claim 11, wherein the particular patient orientation is upright.

13. The method as recited in claim 9, wherein the signal pattern comprises an RFID identifying the medication and changes in a signal strength over time.

14. The method as recited in claim 9, wherein the receiving the signal pattern is via a wireless communication link.

15. The method as recited in claim 9, further comprising:
generating an alert if the comparing the signal pattern to an ingestion profile indicates an invalid consumption of medication.

16. The method as recited in claim 15, further comprising sending the alert to a physician.

17. An apparatus comprising:
a radio frequency identification (RFID) reader to monitor a signal pattern of an RFID tag contained within medication; and
an antenna coupled to the RFID reader to upload the signal pattern to a client device.

18. The apparatus as recited in claim 17, wherein the RFID reader is further to record an RFID identifying the medication and changes in a signal strength of the signal pattern over time.

19. The apparatus as recited in claim 17, further comprising storage for the signal pattern.

20. The apparatus as recited in claim 17, further comprising:
a processing unit to compare the signal pattern to an ingestion profile to distinguish between consumption of the medication and non-consumption of the medication.

21. The apparatus as recited in claim 20, wherein the processing unit is further to generate an alert if the comparison of the signal pattern to an ingestion profile indicates an invalid consumption of medication.

22. The apparatus as recited in claim 17, wherein the RFID reader and the antenna are integrated into an article worn by a patient.

23. An article comprising a storage medium having instructions stored thereon that, when executed by a computing platform, operate to:
receive a monitored signal pattern of a radio frequency identification (RFID) tag contained within medication;
compare the signal pattern to an ingestion profile to distinguish between consumption of the medication and non-consumption of the medication.

24. The article as recited in claim 23, wherein the ingestion profile is designated for a particular medication and comprises a signal strength signature that fluctuates and then decreases over time.

25. The article as recited in claim 23, wherein the ingestion profile is designated for a particular patient orientation.

26. The article as recited in claim 25, wherein the particular patient orientation is prone.

27. The article as recited in claim 23, wherein the signal pattern comprises an RFID identifying the medication and changes in a signal strength over time.

28. The article as recited in claim 23, wherein the instructions further operate to:
generate an alert if the comparing the signal pattern to an ingestion profile indicates an invalid consumption of medication.

29. The article as recited in claim 25, wherein the alert is sent to a physician.

30. A system comprising:
a recording device to monitor a signal pattern of a radio frequency identification (RFID) tag contained within medication; and
a client device in wireless communication with the recording device to receive the signal pattern from the recording device.

31. The system as recited in claim 30, wherein the recording device is further to record an RFID identifying the medication and changes in a signal strength of the signal pattern over time.

32. The system as recited in claim 30, wherein the client device is further to compare the signal pattern to an ingestion profile to distinguish between consumption of the medication and non-consumption of the medication.

33. The system as recited in claim 32, wherein the client device is further to generate an alert if the comparison of the signal pattern to an ingestion profile indicates an invalid consumption of medication.

34. The system as recited in claim 32, wherein the ingestion profile is designated for a particular medication and comprises a signal strength signature that fluctuates and then decreases over time.

35. The system as recited in claim 30, wherein the client device is further to send the signal pattern to a service provider for comparison to an ingestion profile to distinguish between consumption of the medication and non-consumption of the medication.

36. The system as recited in claim 35, wherein the services provider is further to generate an alert if the comparison of the signal pattern to an ingestion profile indicates an invalid consumption of medication.
